(19) United States
(12) Patent Application Publication
(10) Pub. No.: US 2024/0195242 A1
(43) Pub. Date: Jun. 13, 2024

(54) MOTOR

(71) Applicant: LG INNOTEK CO., LTD., Soul (KR)

(72) Inventor: Chang Hyun PARK, Seoul (KR)

(21) Appl. No.: 18/286,815

(22) PCT Filed: Apr. 13, 2022
(86) PCT No.: PCT/KR2022/005359

§ 371 Date: Oct. 13, 2023

(30) Foreign Application Priority Data
Apr. 13, 2021 (KR) 10-2021-0047832

(51) Int. Cl. H02K 1/278

(52) U.S. Cl. CPC H02K 1/278

(57) ABSTRACT

The present invention may provide a motor including a shaft, a rotor coupled to the shaft, and a stator disposed to correspond to the rotor, wherein the rotor includes a rotor core and magnets coupled to the rotor core, the rotor core includes holes which pass through the rotor core in an axial direction and in which the magnets are disposed, an outer circumferential surface of the rotor core includes grooves extending in the axial direction, and a center of the groove does not overlap the hole in a radial direction from the shaft.

### TECHNICAL FIELD

The present invention relates to a motor.

### BACKGROUND ART

In general, a rotor rotates due to an electromagnetic interaction between the rotor and a stator in a motor. In this case, a shaft connected to the rotor also rotates to generate a rotational driving force.

The rotor may include a rotor core and a magnet disposed on the rotor core. The magnet induces an electrical interaction with a coil wound around the stator. In order to secure a required torque of the motor, the magnet may be disposed an outer surface of the rotor core so that the magnet is disposed close to the stator. However, when the magnet is disposed on the outer surface of the rotor core, there is a problem that a separate structure for preventing the magnet from being separated from the rotor core is required.

### DISCLOSURE

### Technical Problem

Accordingly, the present invention is directed to providing a motor having an increased torque while a separate structure for preventing separation of a magnet does not need to be provided.

Objectives to be solved by the present invention are not limited to the above-described objectives, and other objectives which are not described above will be clearly understood by those skilled in the art from the following description.

### Technical Solution

One aspect of the present invention provides a motor including a shaft, a rotor coupled to the shaft, and a stator disposed to correspond to the rotor, wherein the rotor includes a rotor core and magnets coupled to the rotor core, the rotor core includes holes which pass through the rotor core in an axial direction and in which the magnets are disposed, an outer circumferential surface of the rotor core includes grooves extending in the axial direction, and a center of the groove does not overlap the hole in a radial direction from the shaft.

Another aspect of the present invention provides a motor including a shaft, a rotor coupled to the shaft, and a stator disposed to correspond to the rotor, wherein the rotor includes a rotor core and magnets coupled to the rotor core, the rotor core includes first holes and second holes in which the magnets are disposed, an outer circumferential surface of the rotor core includes grooves extending in an axial direction, and the groove is disposed between the first hole and the second hole in a circumferential direction.

Still another aspect of the present invention provides a motor including a shaft, a rotor coupled to the shaft, and a stator disposed to correspond to the rotor, wherein the rotor includes a rotor core and a magnet coupled to the rotor core, the rotor core includes a hole which passes through the rotor core in an axial direction and in which the magnet is disposed, the hole includes a first curved surface, an outer circumferential surface of the rotor core includes a second curved surface formed between two virtual straight lines extending from a center of the rotor core to pass through both ends of the first curved surface of the hole, and the first curved surface and the second curved surface are concentric.

### Advantageous Effects

According to an embodiment, there are advantages that a magnet is disposed in a rotor core and the performance of the motor is also improved.

According to an embodiment, there is an advantage that a separate structure for preventing separation of a magnet is not required.

According to an embodiment, due to a groove disposed in an outer surface of a rotor core and disposed between magnets, there is an advantage that a magnetic flux is prevented from being leaked.

### DESCRIPTION OF DRAWINGS

FIG. 1 is a side cross-sectional view of a motor according to an embodiment.

FIG. 2 is a plan view of a stator and a rotor.

FIG. 3 is a plan view of a rotor core that illustrates a groove and a second curved surface of the rotor core and a first curved surface of a hole.

FIG. 4 is an enlarged view of the rotor core that is an enlarged view illustrating a portion around the hole illustrated in FIG. 3.

FIG. 5 is an enlarged view of the rotor core that illustrates a depth of the groove.

FIG. 6 is a view of a rotor core of a motor according to another embodiment.

FIG. 7 is an enlarged view of the rotor core that illustrates a portion around a hole.

### MODES OF THE INVENTION

A direction parallel to a longitudinal direction (vertical direction) of a shaft is referred to as an axial direction, a direction perpendicular to the axial direction of the shaft is referred to as a radial direction, and a direction along a circle having a radius in the radial direction about the shaft is referred to as a circumferential direction.

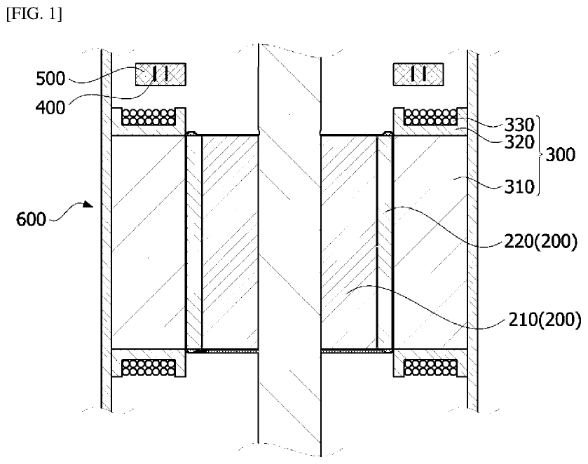

FIG. 1 is a side cross-sectional view illustrating a motor according to an embodiment.

Referring to FIG. 1, the motor according to the embodiment may include a shaft 100, a rotor 200, a stator 300, a busbar 400, a busbar holder 500, and a housing 600.

Hereinafter, the term “inward” is a direction from the housing 600 toward the shaft 100 which is a center of the motor, and the term “outward” is a direction opposite to “inward” which is a direction from the shaft 100 toward the housing 600.

The shaft 100 may be coupled to the rotor 200. When an electromagnetic interaction occurs between the rotor 200 and the stator 300 through the supply of a current, the rotor 200 rotates, and the shaft 100 rotates in conjunction with the rotation of the rotor 200.

The rotor 200 rotates due to an electrical interaction with the stator 300. The rotor 200 may be disposed to correspond to the stator 300 and may be disposed inside the stator 300. The rotor 200 may include a rotor core 210 and magnets 220 disposed on the rotor core 210.

The stator 300 is disposed outside the rotor 200. The stator 300 may include a stator core 310, an insulator 320, and coils 330. The insulator 320 is seated on the stator core 310. The coils 330 are mounted on the insulator 320. The coils 330 induce an electrical interaction with the magnets 220 of the rotor 200.

The busbar 400 may be disposed on the stator 300. The busbar 400 is electrically connected to the coils 330. In addition, the busbar 400 may be connected to an external power source.

The busbar holder 500 supports the busbar 400. The busbar holder 500 may be an annular member which includes the busbar 400 therein.

The housing 600 may be disposed outside the stator 300. The housing 600 may be a cylindrical member having one open side.

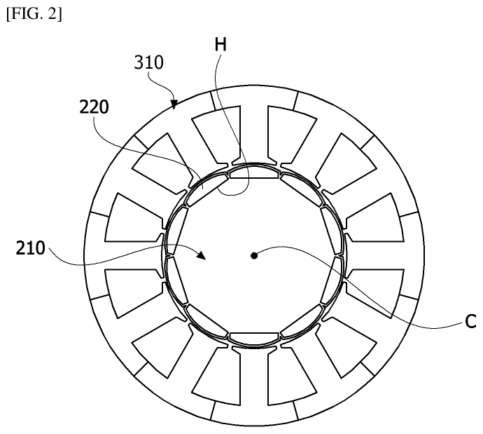

FIG. 2 is a plan view illustrating the stator 300 and the rotor 200.

Referring to FIG. 2, under a condition that the magnets 220 have the same size, it is advantageous for the magnets 220 to be disposed closer to the stator 300 in a radial direction to secure the performance of the motor. When the magnets 220 are inserted into holes H of the rotor core 210, the magnets 220 may be moved away from the stator 300. The motor according to the embodiment secures the performance thereof by arranging the magnets 220 to be maximally close to the stator 300 while inserting the magnets 220 into the holes H of the rotor core 210.

The rotor core 210 includes the holes H. The holes H may be disposed to pass through the rotor core 210 in an axial direction. The magnets 220 are inserted into the holes H. A plurality of holes H may be arranged in a circumferential direction of the rotor core 210. Each of the holes H may have a bread shape corresponding to a shape of each of the magnets 220 in the axial direction. When the magnet 220 is formed so that an outer side of the magnet 220 in the radial direction has a curved surface, the magnet may be disposed closer to the stator 300 while being accommodated in the hole H.

The magnet 220 may be formed in a bread shape so that the outer side has the curved surface and an inner side has a flat surface in the radial direction.

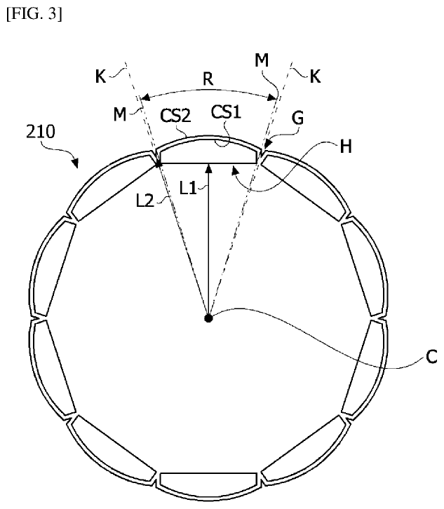

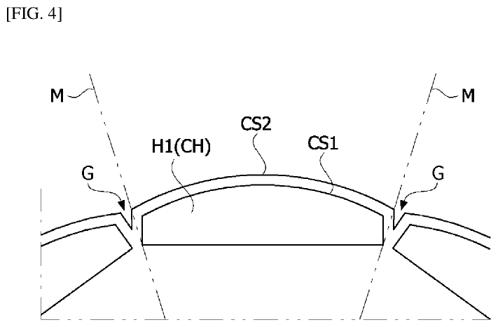

FIG. 3 is a plan view of the rotor core 210 that illustrates a groove and a second curved surface of the rotor core 210 and a first curved surface of the hole H, and FIG. 4 is an enlarged view of the rotor core 210 that is an enlarged view illustrating a portion around the hole H illustrated in FIG. 3.

Referring to FIGS. 3 and 4, the rotor core 210 may include grooves G. The grooves G are disposed to extend from an outer surface of the rotor core 210 in the axial direction. Each of the grooves G may be disposed between the holes H. The holes H are disposed between the magnets 220 adjacent in the circumferential direction to prevent a magnetic flux from not flowing toward the stator 300 and from leaking to the adjacent magnets 220.

The grooves G may be provided as a plurality of grooves G. All gaps R between the plurality of grooves G may the same in the circumferential direction.

The holes H may include first curved surfaces CS1. Each of the first curved surfaces CS1 is one of the inner surfaces of the hole H and is a surface disposed at outer side in the radial direction. The first curved surface CS1 allows the magnet 220 to be disposed as close to the stator 300 as possible.

The rotor core 210 may include a plurality of second curved surfaces CS2. Each of the second curved surfaces CS2 is a part of an outer circumferential surface of the rotor core 210. The plurality of second curved surfaces CS2 may be disposed at equal intervals in the circumferential direction. Each of the grooves G is disposed between the every adjacent second curved surfaces CS2.

The second curved surface CS2 may be formed between two virtual straight lines M. In this case, the two virtual straight lines M are defined as straight lines extending from a center C of the rotor core 210 to pass through two ends of the first curved surface CS1 of the hole H. The grooves G are positioned outside the two virtual straight lines M. A center of curvature of the first curved surface CS1 and a center of curvature of the second curved surface CS2 may be the same. The center of curvature of the first curved surface CS1 and the center of curvature of the second curved surface CS2 may differ from the center C of the rotor core 210.

The first curved surfaces CS1 and the second curved surfaces CS2 may be provided as a plurality of first curved surfaces CS1 and the plurality of second curved surfaces CS2, and a center of a circle formed by the plurality of first curved surfaces CS1 and a center of a circle formed by the plurality of second curved surfaces CS2 may be the same.

Since the first curved surface CS1 and the second curved surface CS2 are concentric, a distance between the first curved surface CS1 and the second curved surface CS2 in the radial direction is constant around the concentric center. In the radial direction, a corresponding area of the rotor core 210 positioned between the first curved surface CS1 and the second curved surface CS2 restricts the magnet 220 from being separated from the rotor core 210. Accordingly, there is an advantage that a separate component for fixing the magnet 220 to the rotor core 210 can be omitted. In addition, since a thickness of the corresponding region of the rotor core 210 positioned between the first curved surface CS1 and the second curved surface CS2 in the radial direction is small, a loss of a magnetic force applied to the stator 300 can be reduced to secure the performance of the motor.

Meanwhile, a shortest distance L1 from the center of the rotor core 210 to the hole H may be smaller than a shortest distance L2 from the center of the rotor core 210 to the groove G.

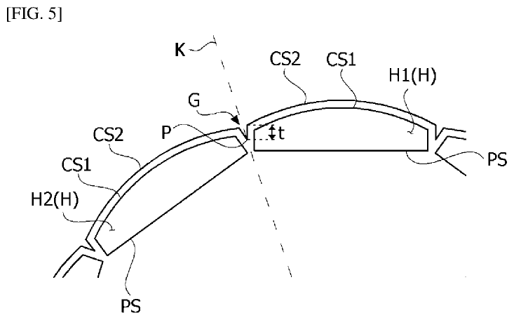

FIG. 5 is an enlarged view of the rotor core that illustrates a depth of the groove.

Referring to FIG. 5, the groove G is disposed so that a center P of the groove G does not overlap the hole H in the radial direction from the shaft 100. In addition, a depth t of the groove G in the radial direction may range from 5% to 6% of a maximum radius of the rotor core 210.

A maximum radius of the rotor core 210 may be a distance from the center of the rotor core 210 to a center of a width of the second curved surface CS2 in the circumferential direction. For example, when the maximum radius of the rotor core 210 is 22.3 mm, the depth t of the groove G may be 1.2 mm.

When the depth t of the groove G is smaller than 5% of the maximum radius of the rotor core 210, there is a risk that a magnetic flux may not flow to the stator 300 and may flow to the adjacent magnet 220 and leak. On the other hand, when the depth t of the groove G is greater than 6% of the maximum radius of the rotor core 210, a strength of the hole H is not secured, and thus there is a risk that the hole is broken.

The holes H may include first a hole H and a second hole H with the groove G interposed therebetween in the circumferential direction. A first groove G and a second groove G are disposed adjacent to each other in the circumferential direction.

Meanwhile, the hole H may include a flat surface PS. The flat surface PS is disposed to face the first curved surface CS1 in the radial direction.

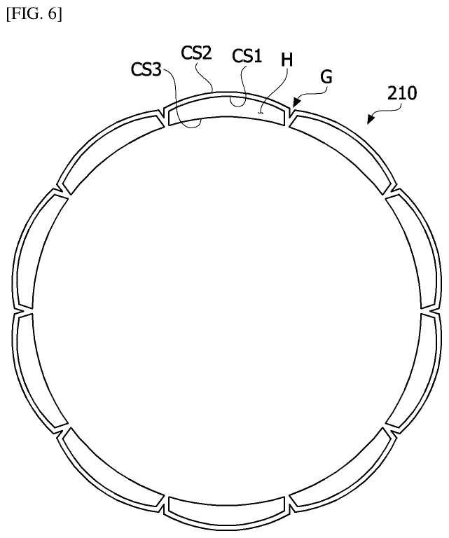

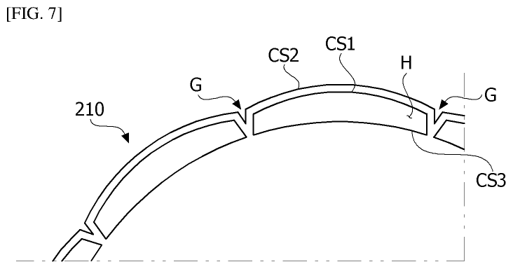

FIG. 6 is a view of a rotor core 210 of a motor according to another embodiment, and FIG. 7 is an enlarged view of the rotor core 210 that illustrates a portion around a hole H.

Referring to FIGS. 6 and 7, the rotor core 210 of the motor according to another embodiment may include a first curved surface CS1, a second curved surface CS2, and a third curved surface CS3. The first curved surface CS1 corresponds to an outer surface of the rotor core 210, and the second curved surface CS2 is an inner surface of the hole H and is a surface disposed at an outer side in a radial direction. The third curved surface CS3 is the inner surface of the hole H and is a surface disposed to face the first curved surface CS1 in the radial direction. A center of a circle formed by the third curved surface CS3 may differ from a center of a circle formed by the first curved surface CS1. And a radius of curvature of the third curved surface CS3 may be greater than a radius of curvature of the first curved surface CS1.

An inner surface of a magnet 220 inserted into the hole H to correspond to the third curved surface CS3 may be formed as a curved surface.

The above-described embodiments can be used in various apparatuses such as vehicles or home appliances.

1. A motor comprising:
a shaft;
a rotor coupled to the shaft; and
a stator disposed to correspond to the rotor,
wherein the rotor includes a rotor core and magnets coupled to the rotor core,
the rotor core includes first holes and second holes in which the magnets are disposed,
an outer circumferential surface of the rotor core includes grooves extending in an axial direction, and
the groove is disposed between the first hole and the second hole in a circumferential direction,
wherein the first hole and the second hole each include a first curved surface, an outer circumferential surface of the rotor core includes a second curved surface formed between two virtual straight lines extending from a center of the rotor core to pass through both ends of the first curved surface of the hole, and the first curved surface and the second curved surface are concentric.

2-10. (canceled)

11. The motor of claim 1, wherein a depth of each of the grooves in a radial direction ranges from 5% to 6% of a maximum radius of the rotor core.

12. The motor of claim 1, wherein a shortest distance from a center of the rotor core to each of the holes is smaller than a shortest distance from the center to each of the grooves.

13. The motor of claim 1, wherein the number of the grooves is equal to the number of the holes.

14. The motor of claim 1, wherein distances between a plurality of grooves in a circumferential direction are the same.

15. The motor of claim 1, wherein:
the first curved surface and the second curved surface are provided as a plurality of first curved surfaces and a plurality of second curved surfaces; and
a center of a circle formed by the plurality of first curved surfaces and a center of a circle formed by the plurality of second curved surfaces are the same.

16. The motor of claim 1, wherein the hole includes a first flat surface disposed to face the first curved surface in a radial direction.

17. The motor of claim 1, wherein:
the hole includes a third curved surface disposed to face the first curved surface in a radial direction; and
a center of a circle formed by the third curved surface differs from a center of a circle formed by the first curved surface.
